(19) United States
(12) Patent Application Publication
(10) Pub. No.: US 2007/0253738 A1
(43) Pub. Date: Nov. 1, 2007

(54) Charging device, process cartridge, image forming apparatus and charging method

(75) Inventors: Tohru Sakuwa, Nara-shi (JP); Kouji Shinkawa, Kitakatsuragi-gun (JP); Toshiaki Kagawa, Kitakatsuragi-gun (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/783,506

(22) Filed: Apr. 10, 2007

(30) Foreign Application Priority Data
Apr. 28, 2006 (JP) 2006-127051

(51) Int. Cl. G03G 15/02

(52) U.S. Cl. 399/176

(57) ABSTRACT

In an image forming apparatus in which a charging roller charges a photoreceptor which is rotating at high speed, damages of the photoreceptor and the charging roller are prevented. The photoreceptor included in an electrophotographic image forming apparatus is rotated at high speed so that a speed of a peripheral surface of the photoreceptor is 225 mm per second or more. Then, the charging roller is rotated by contacting the photoreceptor, so as to charge the photoreceptor. Here, a surface pressure M of a contact portion between the photoreceptor and the charging roller is set to more than 0.8 g/mm² but not more than 3.5 g/mm².

This Nonprovisional application claims priority under 35 U.S.C. § 119(a) on Patent Application No. 127051/2006 filed in Japan on Apr. 28, 2006, the entire contents of which are hereby incorporated by reference.

### FIELD OF THE INVENTION

The present invention relates to a technique of charging, using a contact charging method, a photoreceptor rotated in an electrophotographic image forming apparatus.

### BACKGROUND OF THE INVENTION

In electrophotographic image formation, an electrostatic latent image corresponding to an image is formed on the surface of a photoreceptor. Before forming the electrostatic latent image on the photoreceptor, it is necessary to carry out a charging processing of uniformly charging the surface of the photoreceptor. There are two kinds of methods for charging the photoreceptor, a non-contact charging method and a contact charging method.

In the non-contact charging method, a so-called corotron charger or scorotron charger is used. By corona discharge caused by the charger, electric charge is supplied over the air to the photoreceptor. This non-contact charging method is advantageous in that since the charger does not contact the photoreceptor, it is possible to realize a long life of the photoreceptor. In contrast, the non-contact charging method is disadvantageous in that a by-product, such as ozone, is generated due to the corona discharge, or charging stability/uniformity easily deteriorate due to the deterioration of a discharge electrode. Therefore, in the case of focusing on generating no ozone and/or realizing a long life of the charging stability/uniformity, charging the photoreceptor by using the contact charging method has been discussed.

Among the contact charging methods, there is a method for causing a rubber member, to which a voltage is applied and which is in the shape of a roller, to contact the photoreceptor. A roller including the rubber member is generally called a charging roller. Documents 1 to 5 below disclose a technique of charging the photoreceptor using the charging roller.

However, the charging roller is not adopted in the image forming apparatus whose processing speed is high.

For example, in Document 1, the charging roller is used in the image forming apparatus whose processing speed is 100 mm per second that is a medium-low speed. Similarly, the processing speed is 120 mm per second in Document 3, about 100 mm per second or about 150 mm per second in Document 4, and 94.2 mm per second in Document 5. Thus, either document discloses the image forming apparatus whose processing speed is the medium-low speed. Moreover, there exists no commercially available product which includes the charging roller and whose processing speed is high.

The processing speed is identical with a movement speed of a peripheral surface of the rotating photoreceptor. Therefore, the processing speed being high means that a rotating speed of the photoreceptor is high. If the charging roller is caused to contact, using a conventional method, the photoreceptor which is rotating at high speed, a contact portion between the charging roller and the photoreceptor may be damaged by toner, paper powder, etc. Therefore, it has been conventionally impossible to adopt the charging roller in the image forming apparatus whose processing speed is high.

### (Document 1)

Japanese Unexamined Patent Publication No. 268583/1992 (Tokukaihei 4-268583, published on Sep. 24, 1992)

### (Document 2)

Japanese Unexamined Patent Publication No. 49602/1995 (Tokukaihei 7-49602, published on Feb. 21, 1995)

### (Document 3)

Japanese Unexamined Patent Publication No. 128958/1995 (Tokukaihei 7-128958, published on May 19, 1995)

### (Document 4)

Japanese Unexamined Patent Publication No. 90709/1997 (Tokukaihei 9-90709, published on Apr. 4, 1997)

### (Document 5)

Japanese Unexamined Patent Publication No. 107365/2005 (Tokukai 2005-107365, published on Apr. 21, 2005)

### SUMMARY OF THE INVENTION

The present invention was made to solve the above conventional problems, and an object of the present invention is to prevent a photoreceptor and a charging roller from damaging in an image forming apparatus in which the charging roller charges the photoreceptor which is rotating at high speed.

In order to prevent the photoreceptor and the charging roller from damaging, the present inventor has focused on a surface pressure of the contact portion between the photoreceptor and the charging roller. Regarding commercially available charging rollers, either of them has the surface pressure of 4.0 g/mm² or more, and a JIS-A hardness of the surface of the charging roller is 42° or more. Then, as a result of diligent studies, the present inventor has found that it is possible to prevent the occurrence of the damage by setting the surface pressure of the contact portion to a predetermined value or less. Thus, the present invention has been completed.

That is, in order to solve the above problems, a charging device of the present invention charges an electrophotographic photoreceptor which is being rotated so that a speed of a peripheral surface of the electrophotographic photoreceptor is 225 mm per second or more, and the charging device includes: a charging roller which contacts the electrophotographic photoreceptor so that a surface pressure of a contact portion between the charging roller and the electrophotographic photoreceptor is more than 0.8 g/mm² but not more than 3.5 g/mm².

Moreover, in order to solve the above problems, a charging method of the present invention is for charging an electrophotographic photoreceptor which is being rotated so that a speed of a peripheral surface of the electrophotographic photoreceptor is 225 mm per second or more, and the charging method includes the step of: causing a charging roller, to which a voltage is applied, to contact the electrophotographic photoreceptor so that a surface pressure of a contact portion between the charging roller and the electrophotographic photoreceptor is more than 0.8 g/mm² but not more than 3.5 g/mm².

According to the above configuration, since the surface pressure of the contact portion between the charging roller and the electrophotographic photoreceptor (hereinafter referred to as “photoreceptor”) is more than 0.8 g/mm², it is possible to charge the photoreceptor without the occurrence of slip between the photoreceptor and the charging roller. Then, since the surface pressure is 3.5 g/mm² or less, the photoreceptor and the charging roller are hardly damaged even when the charging roller contacts the photoreceptor which is rotating at high speed. Therefore, it is possible to prevent the photoreceptor and the charging roller from damaging in the image forming apparatus in which the charging roller charges the photoreceptor which is rotating at high speed.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 shows one embodiment of the present invention, and is a perspective view showing configurations of a photoreceptor and a charging device.

FIG. 2 shows one embodiment of the present invention, and is a cross-sectional diagram showing the entire configuration of an image forming apparatus.

FIG. 3 shows one embodiment of the present invention, and is a perspective view showing the configuration of the photoreceptor.

FIG. 4 shows one embodiment of the present invention, and is a partial cross-sectional diagram showing the configuration of layers of the photoreceptor.

FIG. 5 shows one embodiment of the present invention, and is a perspective view showing the configuration of the charging roller.

FIG. 6 is a flow chart showing a procedure of calculating the surface pressure.

FIG. 7 is a diagram showing a relation between hardness and Young's modulus.

FIG. 8 is a diagram showing a relation between a thickness and a correction coefficient of a nip width.

FIG. 9 shows one Example of the present invention, and is a diagram showing results obtained by examining a relation between the surface pressure and the occurrence of the damage by using various charging rollers having different hardness.

FIG. 10 shows one Example of the present invention, and is a diagram showing a relation between a roller diameter and a life of the charging roller.

FIG. 11 shows one Example of the present invention, and is a diagram showing results obtained by examining preferable hardness of the charging rollers on the basis of the relation between the surface pressure and the occurrence of the damage and a relation of a load and chargeability.

### DESCRIPTION OF THE EMBODIMENTS

### Embodiment

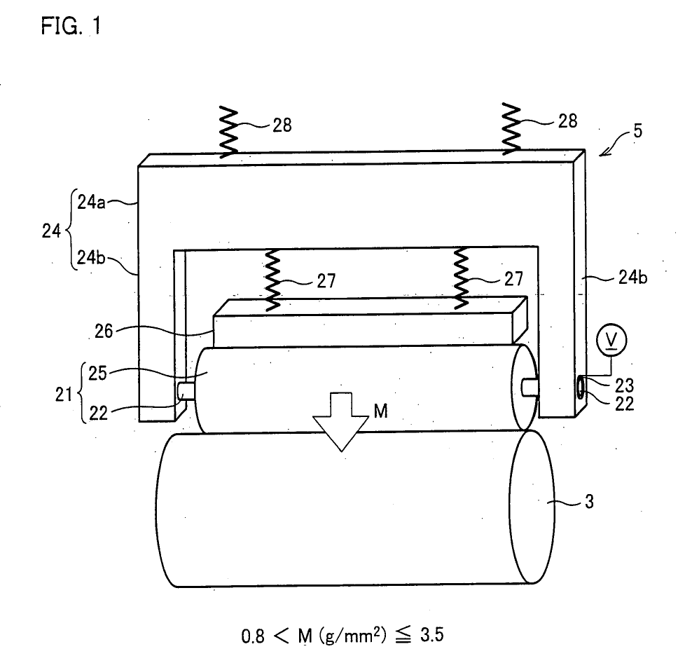

The following will explain one embodiment of the present invention on the basis of FIGS. 1 to 8. An image forming apparatus of the present embodiment forms a color image on a recording sheet on the basis of image data obtained from a scanner or an external device.

(1. Entire Configuration of Image Forming Apparatus)

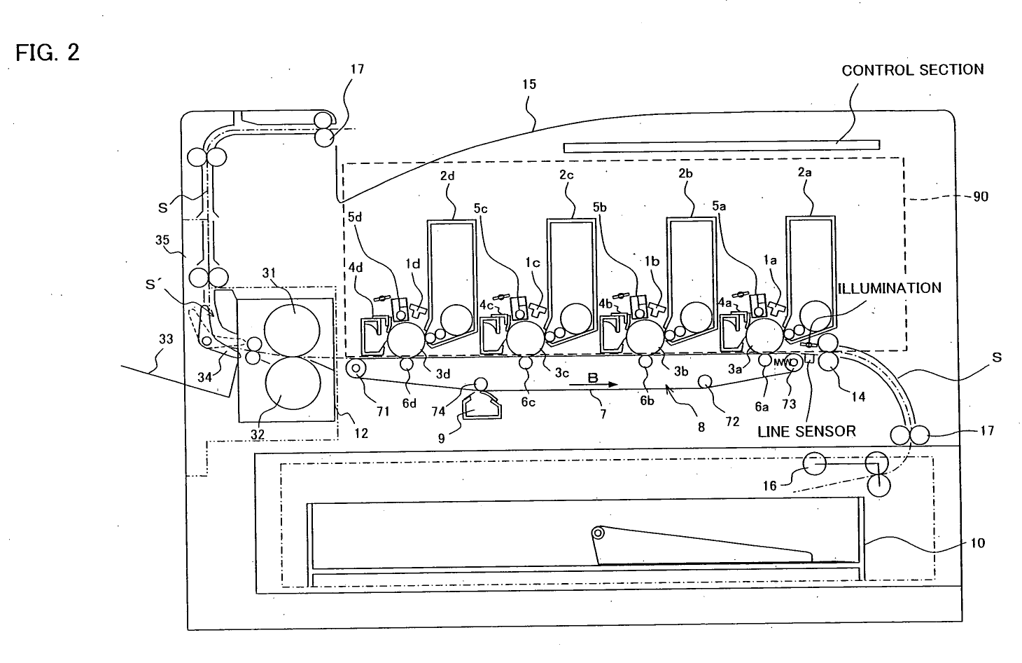

FIG. 2 is an explanatory diagram showing the configuration of the image forming apparatus of the present embodiment. As shown in FIG. 2, the image forming apparatus includes an image forming station 90, a sheet conveyance path S, a transfer/conveyance belt unit 8, a fixing unit 12, a paper feed tray 10 and paper output trays 15 and 33.

The paper feed tray 10 is a tray for storing sheets that are targets of the image formation. The paper output trays 15 and 33 are trays for mounting image-formed sheets. The paper output tray 15 is provided at an upper portion of the image forming apparatus, and mounts printed sheets face-down. Meanwhile, the paper output tray 33 is provided at a side portion of the image forming apparatus, and mounts printed sheets face-up.

The sheet conveyance path S is an S-shaped conveyance path for conveying sheets on the paper feed tray 10 via the transfer/conveyance belt unit 8 and the fixing unit 12 to the paper output tray 15 or 33. In the vicinity of the sheet conveyance path S, a pickup roller 16, a resist roller 14, a conveyance direction switching guide 34 and a conveyance roller 17 for conveying sheets are provided.

The pickup roller 16 is provided close to an edge portion of the paper feed tray 10, picks up the sheets one-by-one from the paper feed tray 10 and supplies them to the sheet conveyance path S. The conveyance roller 17 is a small roller for helping and assisting the conveyance of the sheets, and a plurality of the conveyance rollers 17 are provided along the sheet conveyance path S.

The conveyance direction switching guide 34 switches between the paper output trays 15 and 33 that are destinations of the printed sheets, is provided downstream of the fixing unit 12 in the sheet conveyance path S, and is rotatably provided on a side cover 35. The conveyance direction switching guide 34 outputs the sheet to the paper output tray 15 when the conveyance direction switching guide 34 is in a position shown by a solid line, whereas the conveyance direction switching guide 34 outputs the sheet to the paper output tray 33 when the conveyance direction switching guide 34 rotates so as to be in a position shown by a dotted line.

Note that when the sheet is output to the paper output tray 15, it passes through a conveyance portion S′ (part of the sheet conveyance path S) formed among the fixing unit 12, the side cover 35 and the conveyance direction switching guide 34.

The resist roller 14 once holds the sheet which is being conveyed on the sheet conveyance path S. The resist roller 14 has a function of conveying the sheet in accordance with the rotation of the photoreceptor 3 at such a timing that a multi layer transfer of toner images from the photoreceptor 3 to the sheet is satisfactorily carried out.

That is, the resist roller 14 is set to restart the conveyance of the sheet so that the top edge of the toner image on each photoreceptor 3 meets the top edge of an image-formed range of the sheet on the basis of a detection signal output from a pre-resist detection switch (not shown).

The fixing unit 12 includes a heat roller 31 heated and a pressure roller 32. The heat roller 31 is set to a predetermined temperature on the basis of a temperature detection value (not shown). The heat roller 31 and the pressure roller 32 have a function of sandwiching the sheet onto which the toner image is transferred, rotating, and carrying out thermocompression bonding of the toner image onto the sheet.

The image forming station 90 forms a multicolor image using respective colors of black (K), cyan (C), magenta (M) and yellow (Y). Moreover, in order to form four kinds of latent images corresponding the above four colors, the image forming station 90 includes, for respective colors, exposure units (1a, 1b, 1c and 1d), developing devices (2a, 2b, 2c and 2d), photoreceptors (3a, 3b, 3c and 3d), cleaner units (4a, 4b, 4c and 4d) and charging devices (5a, 5b, 5c and 5d).

Note that the above a, b, c and d correspond to black (K), cyan (C), magenta (M) and yellow (Y), respectively. In the following explanation, the exposure units (1a, 1b, 1c and 1d), the developing devices (2a, 2b, 2c and 2d), the photoreceptors (3a, 3b, 3c and 3d), the cleaner units (4a, 4b, 4c and 4d) and the charging devices (5a, 5b, 5c and 5d) are collectively called an exposure unit 1, a developing device 2, the photoreceptor 3, a cleaner unit 4, and a charging device 5, respectively.

The exposure unit 1 is (i) a write head, such as ELD (electro luminescent display) or LED (light emitting diode) in which light emitting elements are arranged in an array, or (ii) a laser scanning unit (LSU) including a laser irradiation section and a reflection mirror. The exposure unit 1 has a function of exposing the photoreceptor 3 in accordance with externally input image data so as to form, on the photoreceptor 3, the electrostatic latent image corresponding to the image data.

Using respective color toners (K, C, M and Y), the developing device 2 visualizes the electrostatic latent image formed on the photoreceptor 3. The cleaner unit 4 removes and collects the toner remaining on the photoreceptor 3 after the electrostatic latent image formed on the surface of the photoreceptor 3 is developed, and the visualized image is transferred to the sheet or the like.

The charging device 5 uniformly charges the surface of the photoreceptor 3 at a predetermined potential. Details of the charging device 5 and the photoreceptor 3 will be described later.

The transfer/conveyance belt unit 8 is provided below the photoreceptor 3, and includes a transfer belt 7, a transfer belt driving roller 71, a transfer belt tension roller 73, transfer belt driven rollers (72 and 74), a transfer roller 6 (6a, 6b, 6c and 6d) and a transfer belt cleaning unit 9. In the following explanation, four transfer rollers (6a, 6b, 6c and 6d) corresponding to respective colors are collectively called the transfer roller 6.

The transfer belt 7 absorbs and conveys the sheet. The transfer belt 7 is made of, for example, polycarbonate, polyimide, polyamide, polyvinylidene fluoride, polytetrafluoroethylene polymer, or ethylene tetrafluoroethylene polymer. The transfer belt 7 is provided so as to contact the photoreceptor 3.

Then, the respective color toner images formed on the photoreceptors 3 are sequentially transferred to the sheet absorbed and conveyed by the transfer belt 7. Thus, a multicolor toner image is formed. Moreover, the transfer belt 7 has a thickness of about 100 μm to 150 μm, and is formed by an endless film. The transfer belt 7 is not transparent and is black.

The transfer belt driving roller 71, the transfer belt tension roller 73, the transfer roller 6, the transfer belt driven rollers (72 and 74) and the like are for stretching the transfer belt 7 and causing the transfer belt 7 to rotate in an arrow B direction.

The transfer roller 6 is rotatably supported by a transfer roller attaching portion (not shown) of a housing of the transfer/conveyance belt unit 8. The transfer roller 6 is formed by covering the surface of a metal axis, as a base, having a diameter of 8 mm to 10 mm with a conductive elastic material, such as EPDM or urethane foam. Using the conductive elastic material, the transfer roller 6 uniformly applies, to the sheet, a high voltage whose polarity is opposite the polarity of the charge of the toner. Thus, it is possible to transfer the toner image, formed on the photoreceptor 3, to the sheet on the transfer belt 7.

The transfer belt cleaning unit 9 removes and collects toner for color overlap adjustment and toner for process control which toners are directly transferred and adhered to the transfer belt 7. Moreover, the transfer belt cleaning unit 9 remove and collect the toner which is adhered to the transfer belt 7 by contacting the photoreceptor 3.

Next, the following will explain a printing operation in the image forming apparatus.

When the image data is input to the image forming apparatus, the exposure unit 1 exposes the surface of the photoreceptor 3 in accordance with the input image data so that the image is formed on an adjustment position determined in accordance with the color overlap adjustment and the like. Thus, the electrostatic latent image is formed on the photoreceptor 3.

The electrostatic latent image is developed by the developing device 2 so as to become the toner image. Meanwhile, the sheets stored in the paper feed tray 10 are separated one-by-one by the pickup roller 16, and the sheet is conveyed to the sheet conveyance path S and held once by the resist roller 14. The resist roller 14 controls the timing of the conveyance on the basis of the detection signal of the pre-resist detection switch (not shown) so that the top edge of the toner image on the photoreceptor 3 meets the top edge of an image-formed region of the sheet. Then, the sheet is conveyed to the transfer belt 7 in accordance with the rotation of the photoreceptor 3. The sheet is absorbed and conveyed by the transfer belt 7.

The transfer from the photoreceptor 3 to the sheet is carried out by the transfer roller 6 provided to face the photoreceptor 3 via the transfer belt 7. To the transfer roller 6, the high voltage whose polarity is opposite the polarity of the toner is applied. Therefore, the toner image is transferred to the sheet. Four kinds of toner images corresponding to respective colors are sequentially overlapped on the sheet conveyed by the transfer belt 7.

Then, the sheet is conveyed to the fixing unit 12, and the toner image is fixed on the sheet by the thermocompression bonding. Then, the conveyance direction switching guide 34 switches the conveyance path, and the sheet is output to the paper output tray 33, or is output via the sheet conveyance path S′ to the paper output tray 15.

After the transfer to the sheet, the cleaner unit 4 removes and collects the toner remaining on the photoreceptor 3. Moreover, the transfer belt cleaning unit 9 removes and collects the toner adhered to the transfer belt 7. Thus, a series of image forming operations are terminated.

(2. Configurations of Photoreceptor and Charging Device)

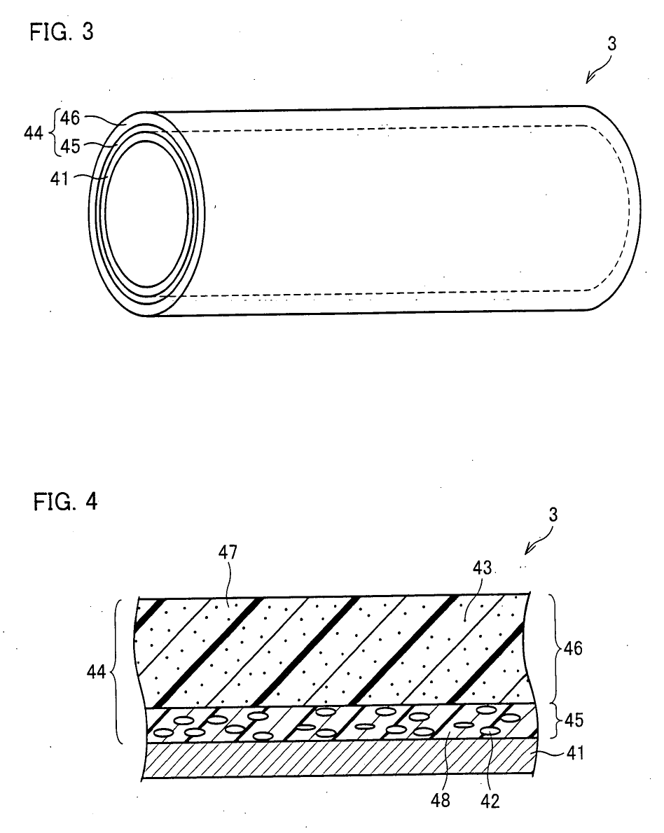

Next, the following will explain the photoreceptor 3 and the charging device 5 which are characteristic members in the image forming apparatus of the present embodiment. First, the photoreceptor 3 will be explained. FIG. 3 is a perspective view of the photoreceptor 3, and FIG. 4 is a partial cross-sectional diagram of the photoreceptor 3.

In the present embodiment, as shown in FIG. 3, the photoreceptor 3 is in the shape of a drum and includes a supporting body 41 and a photosensitive layer 44 formed on the surface of the supporting body 41. Note that the photoreceptor 3 may be in the shape of a belt instead of the drum.

The supporting body 41 supports the photosensitive layer 44. The support body 41 may be (a) a metal material, such as aluminum, an aluminum alloy, copper, zinc, stainless steel, or titanium, (b) a polymer material, such as polyethylene terephthalate, polyester, polyoxymethylene, or polystyrene, hard paper, or glass which have its surface laminated with metal foil, which have a metal material vapor-deposited on the surface, or which have a layer of a conductive compound, such as an electrically conductive polymer, tin oxide, indium oxide, carbon particles, or metal particles, vapor-deposited or applied to the surface.

As shown in FIG. 3, the photosensitive layer 44 includes an electric charge generating layer 45 and an electric charge transporting layer 46 in this order from the surface of the supporting body 41. The electric charge generating layer 45 generates electric charge by receiving light irradiation. As shown in FIG. 4, the electric charge generating layer 45 includes (i) an electric charge generating material (CGM) 42 which generates the electric charge by absorbing the light and (ii) a binder resin 48 which binds the electric charge generating material 42.

The electric charge transporting layer 46 receives the electric charge generated by the electric charge generating layer 45, and transports the electric charge to the surface of the photoreceptor 3. As shown in FIG. 4, the electric charge transporting layer 46 includes (i) an electric charge transporting material (CTM) 43 which transports the electric charge, and (ii) a binder resin 47 which binds the electric charge transporting material 43.

When the photosensitive layer 44 is exposed to light by the light irradiation, the exposed region of the electric charge generating layer 45 generates the electric charge, and the electric charge transporting layer 46 transports the generated electric charge to the surface of the photosensitive layer 44. As a result, the electric charge on the surface of the photosensitive layer 44 is neutralized. Thus, the electrostatic latent image is formed.

The electric charge generating material 42 is desirably such a material that generates the electric charge by light having a wavelength of 400 nm to 800 nm. Specific examples are (i) azo compounds, such as bisazo compounds and trisazo compounds, (ii) phthalocyanine compounds, (iii) squarylium compounds, (iv) azulenium compounds (v) perylene based compounds, (vi) indigo compounds, (vii) quinacridone compounds, (viii) polycyclic quinone compounds, (ix) cyanine pigments, (x) xanthene dyes, and (xi) charge moving complexes, such as poly-N-vinylcarbazole and trinitrofluorenone. These compounds may be used in any combination of two or more of them where necessary. Note that the ratio of the electric charge generating material 42 to the electric charge generating layer 45 is preferably 20% to 80% by weight.

Meanwhile, as the electric charge transporting material 43, it is possible to use, for example, a carbazole derivative, an oxazole derivative, an oxadiazole derivative, a thiazole derivative, a thiadiazole derivative, a triazole derivative, an imidazole derivative, an imidazolone derivative, an imidazolidine derivative, a bisimidazolidine derivative, a styryl compound, a hydrazone compound, a pyrazoline derivative, an oxazolone derivative, a benzimidazole derivative, a quinazoline derivative, a benzofuran derivative, an acridine derivative, a phenazine derivative, an aminostilbene derivative, a triallyl amine derivative, a phenylenediamine derivative, a stilbene derivative, a benzidine derivative, poly-N-vinylcarbazole, poly-1-vinylbilene, or poly-9-vinylanthracene. These compounds may be used in any combination of two or more of them where necessary. Note that the ratio of the electric charge transporting material 43 to the electric charge transporting layer 46 is preferably 20% to 80% by weight.

The binder resins 47 and 48 are, for example, only one resin selected from the group comprising (i) various resins, such as a polyester resin, a polystyrene resin, a polyurethane resin, a phenol resin, an alkyd resin, a melamine resin, an epoxy resin, a silicone resin, an acrylic resin, a methacrylic resin, a polycarbonate resin, a polyarylate resin, a phenoxy resin, a polyvinylbutyral resin, and a polyvinylformal resin, and (ii) copolymer resins containing two or more repeating units of these resins. Alternatively, the binder resins 47 and 48 may be two or more resins selected from that group which are used in mixture form. Moreover, the binder resins 47 and 48 may also be, for example, an insulating copolymer resin, such as a vinyl chloride-vinyl acetate copolymer resin, a vinyl chloride-vinyl acetate-maleic anhydride copolymer resin, or an acrylonitrile-styrene copolymer resin.

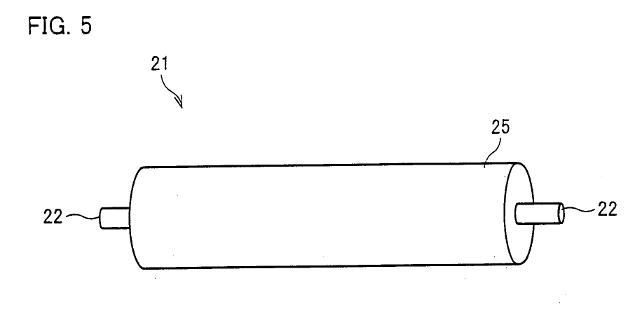

Next, the charging device 5 will be explained. FIG. 1 is a perspective view of the photoreceptor 3 and the charging device 5, and FIG. 5 is a perspective view of a charging roller 21 included in the charging device 5.

As shown in FIG. 1, the charging device 5 includes (i) the charging roller 21 provided to contact the photoreceptor 3, (ii) a cleaning member 26, and (iii) a charging roller frame 24.

The charging roller 21 press-contacts the rotating photoreceptor 3, and rotates by the rotation of the photoreceptor 3. Then, the charging roller 21 has a function of uniformly charging the surface of the photoreceptor 3 using power supplied from a power source V.

The charging roller 21 is made of a conductive rigid body, and includes, as shown in FIG. 1, a rotation axis 22, one end of which is connected with the power source V. A conductive member 25 whose hygroscopicity is low and resistance value is stable is attached by molding to an outer periphery of the rotation axis 22. Then, the high voltage is applied to the rotation axis 22 while the surface of the conductive member 25 is contacting the surface of the photoreceptor 3. Thus, the surface of the photoreceptor 3 is charged uniformly.

As the rotation axis 22, it is possible to use, for example, an axis obtained by molding, in the shape of a rod, a conductive metal, such as stainless steel (SUS). Moreover, as the conductive member 25 attached around the rotation axis 22, it is possible to use (i) a rubber composition using, as a base material, polyurethane, silicon rubber, butadiene rubber, isoprene rubber, chloroprene rubber, styrene-butadiene rubber, ethylene-propylene rubber, polynorbornene rubber, styrene-butadiene-styrene rubber or epichlorohydrin rubber, or (ii) thermoplastic elastomer. The type of the thermoplastic elastomer is not especially limited, and it is possible to use one or a plurality of thermoplastic elastomers selected from general-purpose styrene based elastomers, olefin based elastomers, etc.

The charging roller frame 24 is a frame for supporting the charging roller 21. As shown in FIG. 1, the charging roller frame 24 includes a main bar 24a and two side bars 24b which are respectively attached to edges of the main bar 24a in a vertical downward direction.

The main bar 24a is attached to a fixture (not shown) of the image forming apparatus via a spring (first biasing member) 28 provided on an upper surface of the main bar 24a. Therefore, the charging roller frame 24 is pulled up by the elastic force of the spring 28 in a vertical upward direction (that is, in a direction opposite a direction toward the photoreceptor 3). Therefore, it is possible to prevent the total weight of the charging device 5 from being added to the photoreceptor 3, and to appropriately adjust, by the spring 28, the load applied to the photoreceptor 3 by the charging roller 21.

The side bars 24b directly hold the charging roller 21. That is, as shown in FIG. 1, a bearing 23 is formed at the top edge of each side bar 24b by drilling. Then, using the bearings 23 for supporting the rotation axis 22 of the charging roller 21, two side bars 24b sandwich the charging roller 21 so as to hold it. The diameter of the bearing 23 (the size of the hole) is substantially the same as the diameter of the rotation axis 22 of the charging roller 21, and the rotation axis 22 does not move in an upward or downward direction (in a direction perpendicular to a direction in which the rotation axis 22 extends) in the bearing 23.

The cleaning member 26 is composed of a sponge, an urethane blade, etc., and is a plate-like member having a press-contact surface (cleaning surface) which press-contacts (slide-contacts) the charging roller 21. For example, the cleaning member 26 is formed by combining a rigid body, such as a metallic plate, and an elastic body, such as a sponge. The rigid body is used so that the cleaning member 26 receives uniformly dispersed biasing force. Meanwhile, the elastic body is used to absorb an assembly precision and form precision of the cleaning member 26 so that the cleaning member 26 can uniformly press-contacts the charging roller 21. Then, the press-contact surface of the cleaning member 26 press-contacts (slide-contacts) the surface of the rotating charging roller 21, and cleans deposits, such as toner adhered to the surface.

Note that as shown in FIG. 1, the cleaning member 26 is provided between the charging roller 21 and the charging roller frame 24, and is attached to a lower surface of the main bar 24a of the charging roller frame 24 via a spring 27. Then, the cleaning member 26 press-contacts, by the biasing force of the spring 27, the rotating charging roller 21 sandwiched between the side bars 24b, and cleans the surface of the charging roller 21.

In the image forming apparatus configured as above, it should be especially noted that a surface pressure of a contact portion between the charging roller 21 and the photoreceptor 3 is set in an appropriate range. That is, in the image forming apparatus of the present embodiment, the surface pressure of the contact portion between the charging roller 21 and the photoreceptor 3 is 3.5 g/mm² or less. Moreover, it is preferable that the surface pressure be more than 0.8 g/mm².

As will be described in Examples below, if the surface pressure exceeds 3.5 g/mm² when the charging roller 21 is applied to the image forming apparatus whose processing speed is high, the surfaces of the charging roller 21 and the photoreceptor 3 are damaged by the toner and the paper powder. Meanwhile, if the surface pressure is 0.8 g/mm² or less, slip occurs, so that the charging roller 21 cannot rotate normally by the rotation of the photoreceptor 3.

That is, if the surface pressure is set between 0.8 g/mm² and 3.5 g/mm², it is possible to prevent the surfaces of the charging roller 21 and the photoreceptor 3 from damaging and also possible to prevent the occurrence of the slip between the charging roller 21 and the photoreceptor 3 even in the image forming apparatus whose processing speed is high.

Note that the surface pressure of the contact portion between the charging roller 21 and the photoreceptor 3 cannot be measured directly. However, it can be calculated by the following method. In the present specification, “the surface pressure” means a value calculated by the following method. Note that in the following formulas, “̂” denotes a power, and “exp(A)” denotes e (base of natural logarithm) raised to the Ath power.

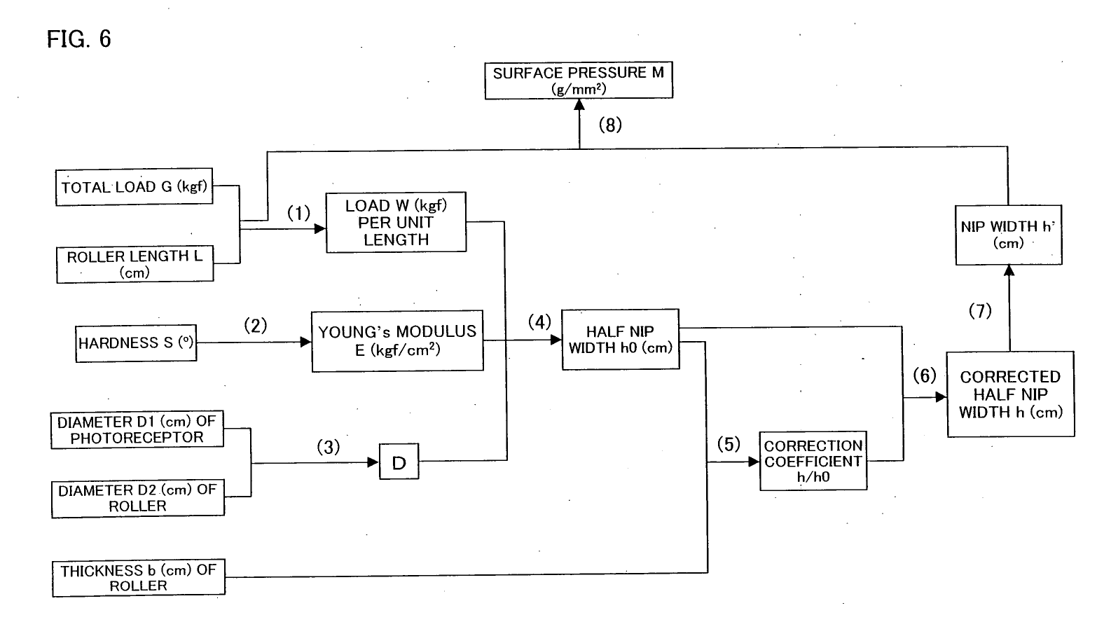

FIG. 6 is a diagram showing a procedure of obtaining the surface pressure. First, a load W per unit length is calculated by Formula (1) below using a total load G (kgf) applied from the charging roller 21 to the photoreceptor 3 and a roller length L (cm) of a shorter one of the charging roller 21 and the photoreceptor 3.

W=G/L (1)

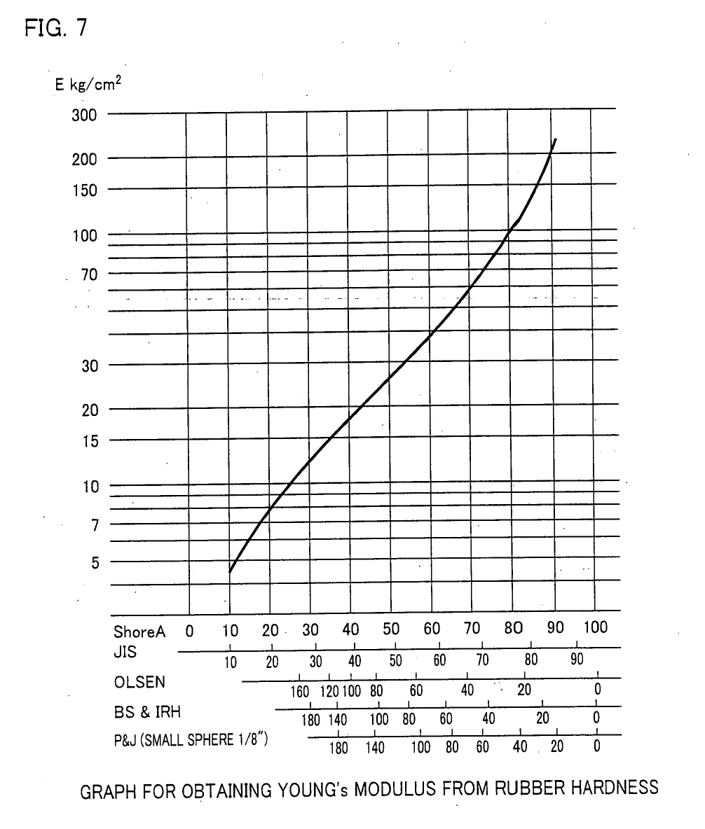

Next, Young's modulus E is obtained using a hardness S of the conductive member 25 of the charging roller 21. Generally, the relation between the hardness S shown by a Gent equation and Young's modulus E can be shown by a graph of FIG. 7. The present application uses the JIS-A hardness as an index of the hardness. Then, Young's modulus E (kg/cm²) is calculated by Approximation Formula (2) below using the JIS-A hardness S (°).

E=2.8764×exp(0.0458×S) (2)

Next, the value of a parameter D is calculated by Formula (3) below using a diameter D1 (cm) of the photoreceptor 3 and a diameter D2 (cm) of the charging roller 21.

1/D=1/D1+1/D2 (3)

Next, a half nip width h0 is calculated by Formula (4) below using the load W per unit length, the parameter D and Young's modulus E.

h0={1.5×(W×D)/(π×E)}̂0.5 (4)

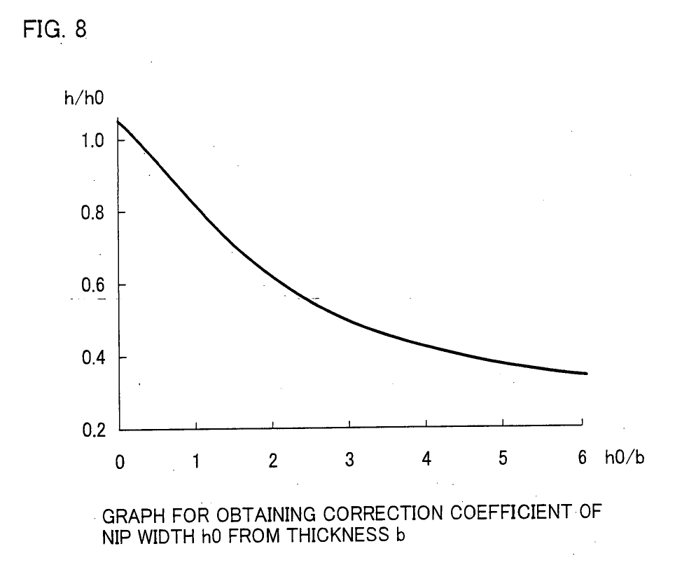

Next, a correction coefficient h/h0 for correcting the half nip width h0 is obtained using a thickness b (cm) of the conductive member 25 of the charging roller 21. Generally, the relation between h/h0 and h0/b can be shown by a graph of FIG. 8. In the present application, h/h0 is calculated by Approximation Formula (5) below.

h/h0=−0.002×(h0/b)̂3+0.0402×(h0/b)̂2−0.289×(h0/b)+1.0586 (5)

Then, the corrected half nip width h is calculated by Formula (6) below using the obtained correction coefficient h/h0.

h=(h/h0)×h0 (6)

Next, a nip width h′ is calculated by Formula (7) below using the corrected half nip width h.

h′=2×h (7)

Finally, the surface pressure M (g/cm²) is calculated by Formula (8) below using the total load G, the roller length L and the nip width h′.

M=1,000×G/(L×h′) (8)

As above, the surface pressure M (g/cm²) can be obtained by Formulas (1) to (8) using the total load G (kgf), the roller length L (cm), the hardness S (°) of the charging roller 21, the diameter D1 (cm) of the photoreceptor 3, the diameter D2 (cm) of the charging roller 21 and the thickness b (cm) of the conductive member 25.

Moreover, as will be described in Examples below, a coefficient of dynamic friction between the charging roller 21 and the photoreceptor 3 is preferably more than 0.23 but less than 0.55, and more preferably from 0.25 to 0.50.

If the coefficient of dynamic friction between the charging roller 21 and the photoreceptor 3 is large, the abrasion of the surface of the photoreceptor 3 accelerates. Meanwhile, if the coefficient of dynamic friction is small, the slip occurs between the photoreceptor 3 and the charging roller 21 which is being rotated by the photoreceptor 3, and poor charging occurs. By setting the coefficient of dynamic friction to be in the above range, it is possible to suppress the abrasion of the photoreceptor 3 and also possible to charge the photoreceptor 3 satisfactorily.

Moreover, as will be described in Examples below, the diameter of the charging roller 21 is preferably ¼ time or more the diameter of the drum-shaped photoreceptor 3. When the diameter of the charging roller 21 is ¼ time the diameter of the photoreceptor 3 in the case of manufacturing the photoreceptor 3 and the charging roller 21 by the above method, the life of the photoreceptor 3 is substantially the same as that of the charging roller 21. Therefore, by setting the diameter of the charging roller 21 to ¼ time or more the diameter of the photoreceptor 3, it is possible to prevent the poor charging caused by the charging roller 21 deteriorated before the deterioration of the photoreceptor 3. Note that the upper limit of the diameter of the charging roller 21 is not especially limited. However, the diameter of the charging roller 21 is usually not more than that of the photoreceptor 3. Note that the diameter of the charging roller 21 being ¼ time or more the diameter of the photoreceptor 3 means that the length, in a rotation direction, of the outer periphery of the charging roller 21 is ¼ time or more the length, in a rotation direction, of the outer periphery of the photoreceptor 3.

Moreover, as will be described in Examples below, the JIS-A hardness of the conductive member 25 is preferably 50° or less. This is because, if the hardness of the conductive member 25 is more than 50°, conditions for satisfactorily securing the chargeability and setting the surface pressure to the above threshold value or less become very tight or disappear.

Usually, the chargeability by the charging roller 21 improves as the load from the charging roller 21 to the photoreceptor 3 increases. Note that when the load from the charging roller 21 to the photoreceptor 3 increases, the surface pressure also increases. Therefore, in order to satisfactorily secure the chargeability and setting the surface pressure to the above threshold value or less, it is necessary to set the load to be in a predetermined range. The size (width) of this range depends on the hardness of the conductive member 25 of the charging roller 21. The more the hardness of the conductive member 25 increases, the narrower the size of the range becomes.

Note that in the image forming apparatus of the present embodiment, the photoreceptor 3 and the charging roller 21 may be provided detachably. That is, the above image forming apparatus may be realized by attaching thereto a process cartridge obtained by integrally constituting at least the photoreceptor 3 and the charging roller 21.

### EXAMPLES

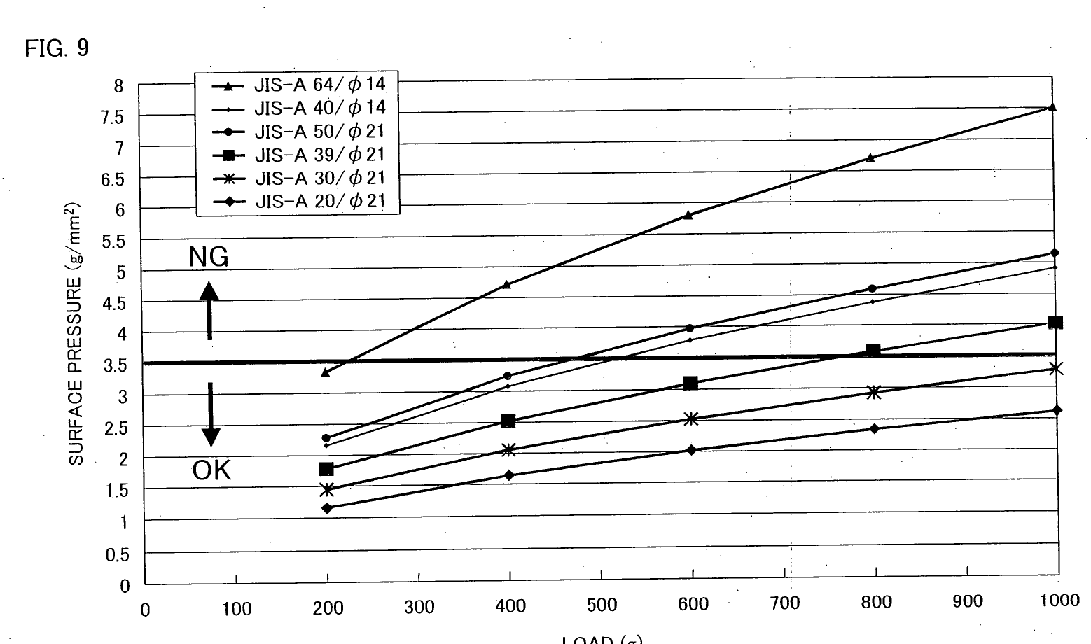

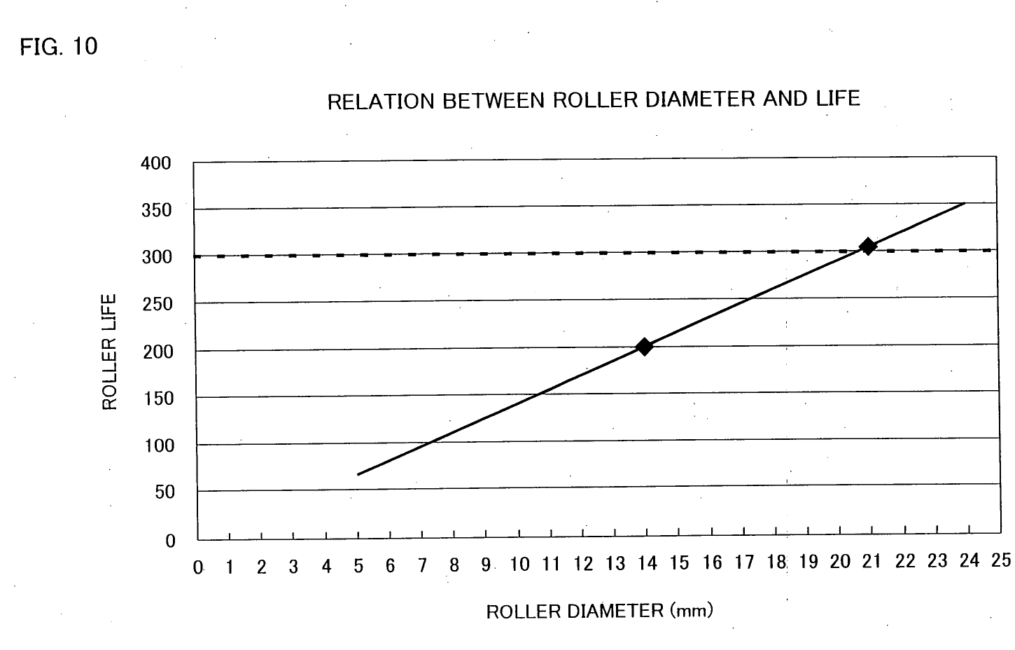

Referring to FIGS. 9 to 11, the following will explain experiments carried out to study various conditions regarding the photoreceptor 3 and the charging roller 21. In respective experiments, the following configurations are common.

Used as the charging roller 21 was a roller obtained by covering an SUS rod with epichlorohydrin rubber. The SUS rod had a diameter of 8 mm, and the charging roller 21 that was the SUS rod covered with epichlorohydrin rubber had a diameter of 21 mm.

Used as the supporting body 41 of the photoreceptor 3 was an aluminium tube having a surface roughness Rmax of 3 μm and a diameter of 80 mm. Prepared as an electric charge generating layer liquid that was a material of the electric charge generating layer 45 of the photoreceptor 3 was a liquid containing the following.

Y type oxo-titanyl phthalocyanine (produced by SYNTEC, Electric charge generating material) . . . 1 part by weight

Polyvinylbutyral (produced by Sekisui Chemical Co., Ltd., Product Name: S-LEC BMS, Binder resin) . . . 1 part by weight

Methyl ethyl ketone (Organic solvent) . . . 98 parts by weight

Moreover, prepared as an electric charge transporting layer liquid that was a material of the electric charge transporting layer 46 was a liquid containing the following.

Styryl based compound (Electric charge transporting material) shown by the following structural formula . . . 100 parts by weight

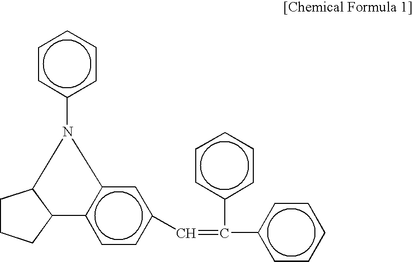

Polycarbonate resin (produced by Teijin Chemicals, Ltd., Product Name: C1400, Viscosity average molecular weight: 38,000, Binder resin) . . . 100 parts by weight

Methyl ethyl ketone (Organic solvent) . . . 800 parts by weight

Silicone oil (produced by Toray Dow Corning Silicone Co., Ltd., Product Name: SH200, Additive) . . . 0.02 parts by weight

Then, the supporting body 41 was soaked in the respective layer liquids for applying the liquids thereto, and the organic solvent was evaporated. Thus, the photosensitive layer 44 was formed.

(Experiment 1. Processing Speed and Surface Pressure)

In the following explanation, various experiments were carried out using a modified version of a digital multifunction device AR-705S produced by Sharp Corporation. First, 300,000 A4-size sheets were printed under conditions of various surface pressures and processing speeds, and then whether or not the surface of the photoreceptor 3 or the charging roller 21 was damaged was visually examined. Results of the examination are shown in Table 1 below.

TABLE 1

| | |
|---|---|
| Surface | |
| Pressure | Process Speed (mm per second) |

| (g/mm²) | 124 | 220 | 225 | 395 | Remarks |
|---|---|---|---|---|---|
| 4.0 | Good | Good | Bad | Bad | |
| 3.5 | Good | Good | Good | Good | |
| 3.1 | Good | Good | Good | Good | |
| 2.8 | Good | Good | Good | Good | |
| 1.8 | Good | Good | Good | Good | |
| 1.0 | Good | Good | Good | Good | |
| 0.8 | Good | Good | Good | Good | Slipped |

“Good” means that the damage hardly occurred.
“Bad” means that the damage occurred.

As shown in Table 1, when the surface pressure was 4.0 g/mm² or more and the processing speed was 225 mm per second or more, the surface of the photoreceptor 3 was damaged. Meanwhile, if the surface pressure was 3.5 g/mm² or less and the processing speed was 395 mm per second, the photoreceptor 3 was not damaged. Note that when the surface pressure was 0.8 g/mm² or less, the slip occurred between the photoreceptor 3 and the charging roller 21.

(Experiment 2. Surface Pressure and Hardness)

Next, 300,000 A4-size sheets were printed under conditions of various surface pressures (loads), and then whether or not the surface of the photoreceptor 3 or the charging roller 21 was damaged was visually examined. Then, this examination was carried out with respect to a plurality of the charging rollers 21 having different hardness and diameters. In the present experiment, the processing speed was 395 mm per second.

The hardness and diameters of the charging rollers 21 used here were as follows.

a) JIS-A 64/φ14
b) JIS-A 40/φ14
c) JIS-A 50/φ21
d) JIS-A 39/φ21
e) JIS-A 30/φ21
f) JIS-A 20/φ21

Note that the hardness of the charging roller 21 was adjusted by the amount of a rubber softening agent (paraffin oil) added.

Results of the examination of these charging rollers 21 are shown in Tables 2 to 7. Note that in Tables 2 to 7, meanings of symbols showing the result of the examination are the same as those used in Experiment 1. Moreover, FIG. 9 shows a graph of these results.

TABLE 2
a) JIS-A 64/φ14

| | Load (g) | | | | |
|---|---|---|---|---|---|
| | 200 | 400 | 600 | 800 | 1,000 |
| Surface | 3.33 | 4.71 | 5.79 | 6.70 | 7.50 |
| Pressure | | | | | |
| (g/mm²) | | | | | |
| Result | Good | Bad | Bad | Bad | Bad |

TABLE 3
b) JIS-A 40/φ14

| | Load (g) | | | | |
|---|---|---|---|---|---|
| | 200 | 400 | 600 | 800 | 1,000 |
| Surface | 2.16 | 3.07 | 3.78 | 4.37 | 4.90 |
| Pressure | | | | | |
| (g/mm²) | | | | | |
| Result | Good | Good | Bad | Bad | Bad |

TABLE 4
c) JIS-A 50/φ21

| | Load (g) | | | | |
|---|---|---|---|---|---|
| | 200 | 400 | 600 | 800 | 1,000 |
| Surface | 2.28 | 3.23 | 3.97 | 4.59 | 5.13 |
| Pressure | | | | | |
| (g/mm²) | | | | | |
| Result | Good | Good | Bad | Bad | Bad |

TABLE 5
d) JIS-A 39/φ21

| | Load (g) | | | | |
|---|---|---|---|---|---|
| | 200 | 400 | 600 | 800 | 1,000 |
| Surface | 1.78 | 2.52 | 3.09 | 3.58 | 4.01 |
| Pressure | | | | | |
| (g/mm²) | | | | | |
| Result | Good | Good | Good | Bad | Bad |

TABLE 6
e) JIS-A 30/φ21

| | Load (g) | | | | |
|---|---|---|---|---|---|
| | 200 | 400 | 600 | 800 | 1,000 |
| Surface | 1.45 | 2.05 | 2.52 | 2.92 | 3.27 |
| Pressure | | | | | |
| (g/mm²) | | | | | |
| Result | Good | Good | Good | Good | Good |

TABLE 7
f) JIS-A 20/φ21

| | Load (g) | | | | |
|---|---|---|---|---|---|
| | 200 | 400 | 600 | 800 | 1,000 |
| Surface | 1.15 | 1.64 | 2.02 | 2.34 | 2.62 |
| Pressure | | | | | |
| (g/mm²) | | | | | |
| Result | Good | Good | Good | Good | Good |

As shown in Tables 2 to 7 and the graph of FIG. 9, it was made clear that by adjusting the load so as to set the surface pressure to 3.5 g/mm² or less, the photoreceptor 3 is not damaged even if the processing speed is high. Thus, even in the case of using the charging roller whose hardness is high, it is possible to prevent the photoreceptor 3 from damaging by reducing the load so as to reduce the surface pressure.

(Experiment 3. Coefficient of Dynamic Friction)

Next, 300,000 A4-size sheets were printed under conditions of various coefficients of dynamic friction between the charging roller 21 and the photoreceptor 3, and then whether or not the photoreceptor 3 is charged satisfactorily and whether or not the surface of the photoreceptor 3 or the charging roller 21 was damaged were examined. Note that in the present experiment, the surface pressure was 3.1 g/mm², the diameter of the charging roller 21 was 21 mm, and the processing speed was 395 mm per second.

The coefficient of dynamic friction between the charging roller 21 and the photoreceptor 3 was measured by using a model produced as below. First, prepared was a sheet material which was made by applying the same photosensitive layer as that of the photoreceptor 3 to a PET film sheet and had a width of 10 mm. The sheet material was placed so that its photosensitive layer contacts the surface of the charging roller 21. Then, a 100 g weight was used to apply load to the sheet material, so that the photosensitive layer of the sheet material press-contacts the charging roller 21. In this state, the sheet material was pulled, and the coefficient of dynamic friction was measured using a friction coefficient measuring device (Product Name: Heidon-14) produced by Heidon. The value of the coefficient of dynamic friction measured using this model was regarded as the coefficient of dynamic friction between the charging roller 21 and the photoreceptor 3. Note that the friction coefficient between the charging roller 21 and the photoreceptor 3 was adjusted by changing the particle size of an abrasive paper for polishing the surface of a rubber material. Results of the examination are shown in Table 8 below.

TABLE 8

Electrophotographic
Characteristic

| Coefficient Of | | Decrease Of Film |
|---|---|---|
| Dynamic Friction | Chargeability | Of Photoreceptor |
| 0.23 | Poor | Satisfactory |
| 0.25 | Satisfactory | Satisfactory |
| 0.31 | Satisfactory | Satisfactory |
| 0.42 | Satisfactory | Satisfactory |
| 0.50 | Satisfactory | Satisfactory |
| 0.55 | Poor | Drastic |

As shown in Table 8, both the chargeability and the decrease of the film of the photoreceptor were satisfactory when the coefficient of dynamic friction was in a range from 0.25 to 0.50. Meanwhile, when the coefficient of dynamic friction was 0.23, there was an uncharged region on the peripheral surface of the photoreceptor 3, the region extending in a circumferential direction. This may be because the slip occurred between the photoreceptor 3 and the charging roller 21. Moreover, when the coefficient of dynamic friction was 0.55, the decrease of the film of the photoreceptor 3 was drastic. Therefore, a predetermined charge voltage could not be secured on the peripheral surface of the photoreceptor 3.

(Experiment 4. Roller Diameter and Life of Charging Roller)

Next, examined was the relation between the life and roller diameter of the charging roller 21. The life of the charging roller 21 depends on the frequency of contact with the photoreceptor 3. Therefore, the ratio of the drum diameter of the photoreceptor 3 to the roller diameter of the charging roller 21 may be important. Here, examined were the lives of the charging rollers 21 having the roller diameters (diameters) of 14 mm and 21 mm. Used as an index for the life of the charging roller 21 was the number of A4-size sheets printed until when a failure of the charging roller 21 occurred. Note that in the present experiment, the photoreceptor 3 has the drum diameter (diameter) of 80 mm and can carry out the image formation onto 300,000 A4-size sheets, and the processing speed was 395 mm per second. Results are shown in Tables 9 and 10.

TABLE 9

| Roller Diameter (mm) | Life (Number Of Sheets) |
|---|---|
| 14 | 200,000 |
| 21 | 300,000 |

As shown in Tables 9 and 10, it was made clear that the charging roller 21 having the roller diameter of 21 mm can secure the same life (3000,000 sheets) as the photoreceptor 3 having the drum diameter of 80 mm. Therefore, it may be preferable that the roller diameter of the charging roller 21 be ¼ time or more the drum diameter of the photoreceptor 3.

(Experiment 5. Load and Chargeability)

Next, examined was the relation between the load from the charging roller 21 to the photoreceptor 3 and the chargeability with respect to the photoreceptor 3. Used as the charging roller 21 in the present experiment were three rollers each having the roller diameter of 21 mm and the JIS-A hardness of 55°, 50° or 39°. Moreover, the drum diameter of the photoreceptor 3 was 80 mm, and the processing speed was 395 mm per second. Results were shown in Table 10.

TABLE 10

| | |
|---|---|
| Hardness | Load (g) |

| | | | | | |
|---|---|---|---|---|---|
| (°) | 200 | 400 | 600 | 800 | 1,000 |

| | | | | | |
|---|---|---|---|---|---|
| 55 | Bad | Good | Good | Good | Good |
| 50 | Bad | Good | Good | Good | Good |
| 39 | Bad | Good | Good | Good | Good |

“Good” means that the chargeability was satisfactory.
“Bad” means that the poor charging occurred.

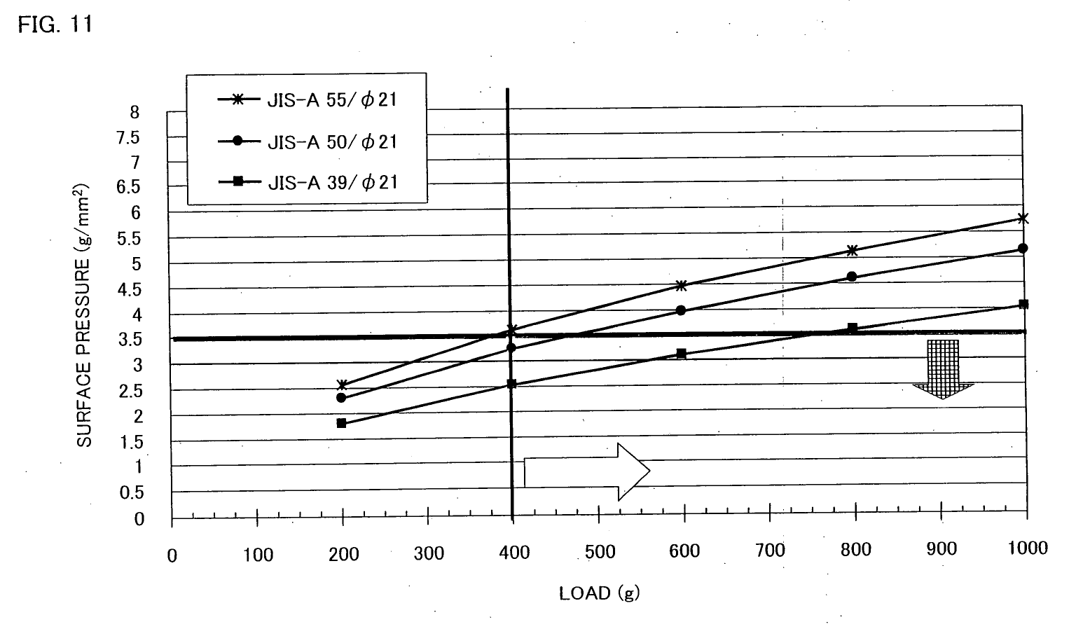

As shown in Table 10, regardless of the hardness of the charging roller 21, the chargeability was satisfactory when the load from the charging roller 21 to the photoreceptor 3 was 400 g or more. Therefore, in light of the results of Experiment 2, FIG. 11 can be obtained. That is, in the case of the charging roller 21 whose hardness was 55°, it is impossible to realize that the surface pressure is 3.5 g/mm² or less and the load is 400 g or more. Therefore, it is clear that it is difficult to prevent the surfaces of the charging roller 21 and the photoreceptor 3 from damaging and at the same time secure the satisfactory chargeability. This indicated that the JIS-A hardness of the charging roller 21 is preferably 50° or less.

As above, the charging device of the present invention includes the charging roller which contacts the above electrophotographic photoreceptor so that the surface pressure of the contact portion is more than 0.8 g/mm² but not more than 3.5 g/mm². Moreover, each of the process cartridge and the image forming apparatus of the present invention includes the charging device and the photoreceptor. Further, in the charging method of the present invention, the charging roller to which a voltage is applied is arranged so as to contact the electrophotographic photoreceptor so that the surface pressure of the contact portion is more than 0.8 g/mm² but not more than 3.5 g/mm².

Therefore, as described above, in the image forming apparatus in which the charging roller charges the photoreceptor which is rotating at high speed, it is possible to prevent the photoreceptor and the charging roller from damaging.

Moreover, in charging device, it is preferable that the coefficient of dynamic friction at the contact portion between the electrophotographic photoreceptor and the charging roller be more than 0.23 but less than 0.55.

As a result of studies, the present inventor revealed that when the coefficient of dynamic friction at the contact portion between the photoreceptor and the charging roller is 0.23 or less, the slip occurs between the photoreceptor and the charging roller, and the poor charging occurs. Then, the present inventor also revealed that the poor charging does not occur at all when the coefficient of dynamic friction is 0.25 or more. Meanwhile, the present inventor further revealed that the abrasion on the surface of the photoreceptor by the friction is significant when the coefficient of dynamic friction is 0.55 or more, and this abrasion can be practically suppressed when the coefficient of dynamic friction is 0.50 or less.

Here, according to the above configuration of the present invention, since the coefficient of dynamic friction at the contact portion between the photoreceptor and the charging roller is less than 0.23, it is possible to prevent the occurrence of the poor charging caused by the slip between the photoreceptor and the charging roller. Moreover, since the coefficient of dynamic friction is less than 0.55, the abrasion of the surface of the photoreceptor does not accelerate. Therefore, it is possible to suppress the abrasion of the photoreceptor and also possible to charge the photoreceptor satisfactorily.

Moreover, in the charging device, it is preferable that the JIS-A hardness of the charging roller be 500 or less.

Usually, the chargeability by the charging roller improves as the load from the charging roller to the photoreceptor increases. Note that if the load from the charging roller to the photoreceptor increases, the surface pressure also increases. Therefore, in order to secure the chargeability satisfactorily and set the surface pressure to the above threshold value or less, it is necessary to set the load to be in a predetermined range. This range depends on the hardness (of the surface) of the charging roller. The more the hardness increases, the narrower the range becomes. Then, as a result of studies, the present inventor revealed that the above appropriate range hardly exists when the JIS-A hardness of the charging roller is 55° or more, and the above appropriate range exists when the hardness of the charging roller is 50° or less.

Here, according to the above configuration of the present invention, since the hardness of the charging roller is 50° or less, it is possible to realize conditions for securing the chargeability satisfactorily and setting the surface pressure to the above threshold value or less.

Moreover, in the charging device, it is preferable that the length, in the rotation direction, of the outer periphery of the charging roller be 0.25 time or more the length, in the rotation direction, of the outer periphery of the electrophotographic photoreceptor.

If the charging roller deteriorates before the deterioration of the photoreceptor, the poor charging to the photoreceptor occurs. Here, since the charging roller is worn out by the contact with the photoreceptor, the life of the charging roller depends on the frequency of contact with the photoreceptor. Therefore, in order to extend the life of the charging roller more than the life of the photoreceptor, it is necessary to set, to be in a predetermined range, the ratio of the length, in the rotation direction, of the outer periphery of the charging roller to the length, in the rotation direction, of the outer periphery of the photoreceptor. Then, as a result of studies, the present inventor revealed that the life of the charging roller became substantially the same as that of the photoreceptor when the length of the outer periphery of the charging roller is about 0.25 time the length of the outer periphery of the photoreceptor.

Here, according to the above configuration of the present invention, since the length of the outer periphery of the charging roller is 0.25 time or more the length of the outer periphery of the photoreceptor, it is possible to suppress the occurrence of the poor charging caused by the charging roller deteriorated before the deterioration of the photoreceptor.

Moreover, it is preferable that the charging roller be hanged via an elastic member and contact an upper portion of the photoreceptor.

According to the above configuration, the charging roller is pulled by the elastic force of the elastic member in a direction opposite a direction toward the photoreceptor (in an upper direction). As a result, it is possible to prevent the total weight of the charging roller from applying to the photoreceptor, and possible to apply part of the weight of the charging roller to the photoreceptor. Therefore, it becomes easy to adjust the load from the charging roller to the photoreceptor.

Note that the charging roller may rotate by the rotation of the photoreceptor.

Moreover, in order to solve the above problems, the process cartridge of the present invention includes the charging device and the electrophotographic photoreceptor. Moreover, in order to solve the above problems, the image forming apparatus of the present invention includes the charging device and the electrophotographic photoreceptor.

According to the above configuration, since the charging device and the photoreceptor are included, it is possible to prevent the photoreceptor and the charging roller from damaging in the image forming apparatus in which the charging roller charges the photoreceptor which is rotating at high speed.

According to the present invention, when charging the photoreceptor which is rotating at high speed, it is possible to prevent the photoreceptor the charging roller from damaging. Therefore, the present invention is preferably applicable to the image forming apparatus which can execute processing at high speed.

The present invention is not limited to the description of the embodiments above, but may be altered by a skilled person within the scope of the claims. An embodiment based on a proper combination of technical means disclosed in different embodiments is encompassed in the technical scope of the present invention.

Moreover, needless to say, a numerical range other than the numerical range described in the present specification is included in the present invention as long as it is a rational range which does not go beyond the spirit of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A charging device charging an electrophotographic photoreceptor which is being rotated so that a speed of a peripheral surface of the electrophotographic photoreceptor is 225 mm per second or more, the charging device comprising:
a charging roller which contacts the electrophotographic photoreceptor so that a surface pressure of a contact portion between the charging roller and the electrophotographic photoreceptor is more than 0.8 g/mm² but not more than 3.5 g/mm².

2. The charging device as set forth in claim 1, wherein a coefficient of dynamic friction at the contact portion between the electrophotographic photoreceptor and the charging roller is more than 0.23 but less than 0.55.

3. The charging device as set forth in claim 2, wherein a JIS-A hardness of the charging roller is 500 or less.

4. The charging device as set forth in claim 3, wherein a length, in a rotation direction, of an outer periphery of the charging roller is 0.25 time or more a length, in a rotation direction, of an outer periphery of the electrophotographic photoreceptor.

5. The charging device as set forth in claim 1, wherein the charging roller is hanged via an elastic member and contact an upper portion of the electrophotographic photoreceptor.

6. The charging device as set forth in claim 1, wherein the charging roller rotates by rotation of the electrophotographic photoreceptor.

7. A process cartridge, comprising:
an electrophotographic photoreceptor which is rotated so that a speed of a peripheral surface the electrophotographic photoreceptor is 225 mm per second or more; and
a charging roller which charges the electrophotographic photoreceptor, and contacts the electrophotographic photoreceptor so that a surface pressure of a contact portion between the charging roller and the electrophotographic photoreceptor is more than 0.8 g/mm² but not more than 3.5 g/mm².

8. An electrophotographic image forming apparatus in which a photoreceptor is rotated so that a speed of a peripheral surface of the photoreceptor is 225 mm per second or more, the electrophotographic image forming apparatus comprising:
the photoreceptor; and
a charging roller which contacts the photoreceptor so as to charge the photoreceptor,
a surface pressure of a contact portion between the photoreceptor and the charging roller being more than 0.8 g/mm² but not more than 3.5 g/mm².

9. A method for charging an electrophotographic photoreceptor which is being rotated so that a speed of a peripheral surface of the electrophotographic photoreceptor is 225 mm per second or more, the method comprising the step of:
causing a charging roller, to which a voltage is applied, to contact the electrophotographic photoreceptor so that a surface pressure of a contact portion between the charging roller and the electrophotographic photoreceptor is more than 0.8 g/mm² but not more than 3.5 g/mm².
